(19) United States
(12) Patent Application Publication
(10) Pub. No.: US 2024/0371271 A1
(43) Pub. Date: Nov. 7, 2024

(54) METHOD FOR CREATING A MAP WITH COLLISION PROBABILITIES

(71) Applicant: Continental Automotive Technologies GmbH, Hannover (DE)

(72) Inventors: Ulrich Stählin, Eschborn (DE); Marc Menzel, Weimar (DE)

(73) Assignee: Continental Automotive Technologies GmbH, Hannover (DE)

(21) Appl. No.: 18/556,795

(22) PCT Filed: Mar. 16, 2022
(86) PCT No.: PCT/DE2022/200042

§ 371 Date: Oct. 23, 2023

(30) Foreign Application Priority Data
Apr. 23, 2021 (DE) 10 2021 204 067.5

(51) Int. Cl. G08G 1/16; G08G 1/01

(52) U.S. Cl. CPC G08G 1/164; G08G 1/0112; G08G 1/0133

(57) ABSTRACT

A method for creating a map with collision probabilities for an area including a plurality of vehicles.

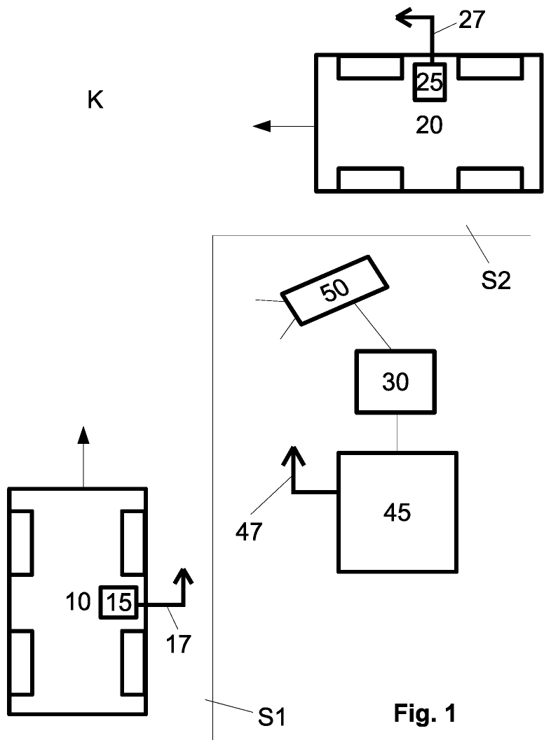

### CROSS-REFERENCE TO RELATED APPLICATIONS

The present application is a National Stage Application under 35 U.S.C. § 371 of International Patent Application No. PCT/DE2022/200042 filed on Mar. 16, 2022, and claims priority from German Patent Application No. 10 2021 204 067.5 filed on Apr. 23, 2021, in the German Patent and Trademark Office, the disclosures of which are herein incorporated by reference in their entireties.

### BACKGROUND

### 1. Field

Embodiments of the present application relate to a method for creating a map with collision probabilities for an area.

### 2. Description of Related Art

Intersections or other places on public traffic routes fundamentally carry a certain risk of accidents. Accidents can happen, for example, when two vehicles collide. For example, environmental sensors can be used to collect information about this, thus enabling infrastructure operators such as cities or municipalities to analyze accident black spots.

It would be desirable to provide a method for creating a map with collision probabilities, which method has a design that is alternative to or better than known designs.

### SUMMARY

Aspects and objects of embodiments of the present application relate to a method for creating a map with collision probabilities for an area, including detecting one or more vehicles driving in the area, and determining movement data relating to the respective vehicle, predicting, for each of the vehicles, at least one trajectory based on the movement data, calculating collision probabilities based on the trajectories, and storing the collision probabilities in the map.

Such a method can be used to create a map with collision probabilities which is based on actually captured movement data and can also be based on calculation models which are already used, for example, for vehicle control. Such calculation models are typically not executed by the respective vehicles in the method described herein, but by an infrastructure which can be set up, for example, specifically for the creation of such maps with collision probabilities.

The detection of vehicles and the determination of movement data can be carried out, for example, using suitable sensors such as cameras or motion sensors, but it can also be carried out, for example, via data obtained during vehicle-to-X communication. For example, models based on deterministic algorithms and/or statistical methods and/or artificial intelligence can be used for predicting. For example, collision probabilities can be calculated in such a way that the probability with which trajectories overlap or regions around trajectories overlap is checked.

The map may be, for example, an electronically stored map which can be stored, for example, in a central unit. It can then be used, for example, to evaluate accident black spots and to identify possible ways of improving traffic safety.

For example, movement data can be determined repeatedly during a journey of the respective vehicle through the area and at least one trajectory can be predicted on the basis thereof in each case. This can improve the map since it is possible to resort to a broader potential of data. However, corresponding data can also be used for separate maps.

In particular, movement data can be determined at predetermined time intervals. This enables a simple embodiment.

According to one embodiment, a plurality of trajectories with respective associated probabilities are always or at least partially predicted. This applies in particular to a respective vehicle. As a result, it is possible to predict how the vehicle will move on and with what probability, and, in particular, a probability can be assigned to each possible movement sequence. This makes it easier to calculate collision probabilities.

Movement data can be detected and/or determined in particular by means of information received via radio from the vehicles. For example, vehicle-to-X communication can be used for this purpose. However, it is also possible to use road-side sensors such as cameras, radars, lidar sensors, etc.

In particular, the area may include an intersection, a junction, a bend or a T-junction. Such places are typically accident black spots. However, other areas can also be used.

In particular, the collision probabilities can be normalized to a reference value. The map can then be executed such that it does not indicate the absolute probability, but rather a relative probability compared to a reference value.

For example, the collision probabilities can be stored in a manner aggregated in predefined subdivisions of the area. This allows the map to be suitably divided in order to avoid an excessively fine-grained design. This allows certain evaluations in aggregated form.

In particular, a prediction uncertainty and/or error limits when determining movement data can be taken into account when predicting trajectories and associated probabilities. This can further improve the calculation. In particular, a plurality of trajectories with respective probabilities can be calculated based on the uncertainty and/or the error limits.

In particular, the collision probabilities of a plurality of vehicle pairings can be stored in an aggregated manner. A pairing can be understood in particular as meaning that two vehicles come so close that there is at least a certain probability of collision. Aggregated storage can also be used to achieve an aggregated evaluation.

If only one vehicle is considered, a collision probability for a collision with a fixed obstacle can be considered, in particular. In this case, typically a trajectory or trajectories starting from the single vehicle is/are sufficient.

In particular, the collision probabilities can be stored in the map in such a way that the map only considers collision probabilities from a predefined time window. As a result, the map can be created, for example, in such a way that it allows an evaluation with regard to an improvement in the traffic safety at certain times, in which case typically there is a different traffic volume at different times. A sliding window functionality can also be implemented so that the map is always created for a predefined period in the past.

According to one embodiment, one or more maps are generated, wherein only collision probabilities that meet one or more predefined conditions are taken into account for each map. This makes it possible, for example, to generate maps with different features. Some examples are mentioned below, especially for conditions: different map depending on the prediction horizon, for example one map for a prediction time of e.g. 1 s, 2 s, 3 s etc., map for different times, for example one map for 6 a.m. to 10 a.m., 10 a.m. to 3 p.m., 3 p.m. to 7 p.m., 7 p.m. to 10 p.m., etc., and/or for certain days of the week, map only for certain combinations of objects, for example one map for vehicle-vehicle, vehicle-pedestrian, bicycle-pedestrian, bicycle-automobile, truck-VRU, etc., map that does not show the collision probabilities, but rather the locations of the objects involved if the collision probability exceeds a certain threshold value. This can be advantageous, in particular, if it is to be determined where the objects involved come from or where there could be structural reasons for collision risks. map for different traffic light phases or times until the traffic light phase changes, map depending on the object density, for example one map for a few objects, a normal number of objects, a very large number of objects and an overflowing number of objects in the viewing area, possibly also differentiated according to object types, for example “a very large number of pedestrians”, etc., map as a deviation from the standard. For example, a map describing the basic state can be created first, and from then on, further maps representing the difference from this basic state can be created. This can be particularly useful when the result of a change is to be shown.

The method may be carried out in particular in such a way that one or more near-collision events are determined based on the fact that no collision of the vehicles occurred at a location with a high collision probability between two vehicles. Such near-collision events are particularly valuable for improving accident black spots with regard to traffic safety, since they cannot be determined on the basis of real events, unlike actual accidents.

For example, when reading collision probabilities from a map, each collision probability to be read can be assigned to one of a plurality of predefined areas and this area can be output in each case. This can mean, in particular, that the readout is coarser than the map would actually allow, which allows an aggregated view and a simplification of the evaluation.

According to an aspect of an embodiment, there is provided a calculation module which is configured to execute a method as described herein. According to an aspect of an embodiment, there is provided a non-volatile, computer-readable storage medium on which program code is stored, during the execution of which a processor executes a method as described here. In respect of the method, reference can in each case be made here to all of the embodiments and variants described herein.

For example, an infrastructure installation that has at least one environmental sensor (e.g. radar, camera, lidar, ultrasound, . . . ) and/or a vehicle-to-X communication module can be considered as the basis. A movement prediction can be created for each detected object. A check is then carried out in order to determine whether the movement predictions of two or more objects overlap and therefore there is a risk of collision. Ideally, but not necessarily, both the movement prediction and the collision risk detection take place with implicit consideration of both the detection error and the prediction inaccuracy.

An example is given below. A vehicle is detected and its position is accurately detected to ±0.5 m, its speed to ±1 m/s and its direction of movement to ±1°. The prediction is now created as a kind of movement fan, with a most likely path in the middle (assuming no errors) and outer boundaries, assuming detection errors and changes in the driving dynamics during the prediction time.

The collision risks determined in this manner can be recorded on a map which can be in the form of a “heat map”, for example. For each location and for each combination of objects, the collision risk in the range of 0% to 100% can be added to the other collision risks.

For a better assessment of the heat map or map, a grid can be used as the location for the assessment, i.e. the collision probability is added up only for positions at a distance of, for example, 10 cm or another distance.

The map or heat map can also be normalized if it is not the absolute collision probability that is important, but only the relative collision probability, i.e. if it is asked where an accident will most likely occur. For this purpose, the added collision probabilities are divided by the greatest collision probability in the given viewing area.

The collision probabilities can also be added as a sliding window. Only the collision probabilities of the last x seconds or minutes or hours are added up.

For differentiated analysis, a plurality of maps or heat maps can also be created. Possible differences have already been described further above.

In particular, the view can be simplified if only clusters of collision probabilities are considered instead of the collision probabilities. The collision probabilities could thus be divided into the clusters, for example <50%, 50% to 75%, 75% to 90%, >90%. It is then possible to count, for example, how often each of the clusters is reached (dedicated heat maps per cluster), or each cluster receives a rating number and these are summed (for example, for the example above, this could be 1, 3, 7, 15).

A map or heat map can also be used to identify so-called “near misses”, especially if high collision probabilities are determined in short prediction times, but no collision occurs. In order to identify additional near misses, i.e. near-collision events, a minimum spatiotemporal distance (distance of the four-dimensional space-time vectors) can be calculated for each combination of vehicle trajectories of the driving fans that exceeds a certain minimum probability with regard to the collision probability. This space-time can then be weighted with the probability of the trajectory pair, for example, and summed up. As of a threshold value, this weighted space-time distance is evaluated as a near miss and can be entered again in a heat map at the position of the smallest distance. The advantage of this second approach is, in particular, that even narrow passes with very well-defined speeds and directions, which did not have great collision probabilities, are recognized as near misses.

In addition to or in place of heat maps, the collision probability can also be provided as additional functions or devices of the system. This can be done, for example, in the form of raw data or as a trigger if a collision probability exceeds a certain value. Danger points and near misses can be identified on the basis of relatively well-known methods.

It is also possible to identify situations or locations that are uncomfortable or difficult for drivers to cope with. This can be used to make structural changes or adjust traffic flow control before an accident happens.

### BRIEF DESCRIPTION OF THE DRAWINGS

Embodiments are herein described below with reference to the drawing, which shows a situation with two vehicles in front of an intersection.

### DETAILED DESCRIPTION

The FIGURE shows purely schematically a first vehicle 10 and a second vehicle 20. The first vehicle 10 moves on a first road S1 and the second vehicle 20 moves on a second road S2. Both vehicles 10, 20 are moving on the roads S1, S2 toward an intersection K, where the two roads S1, S2 intersect. The first vehicle 10 has a vehicle-to-X communication module 15 with an antenna 17 attached thereto. The second vehicle 20 has a vehicle-to-X communication module 25 with an antenna 27 attached thereto. This allows the two vehicles 10, 20 to participate in vehicle-to-X communication.

A road-side vehicle-to-X communication module 45 with an antenna 47 is arranged beside the roads S1, S2. This also allows the vehicles 10, 20 to communicate with the road-side infrastructure. A computing unit 30 is arranged beside the roads S1, S2 and can be used to create a map.

Furthermore, a camera 50 is arranged beside the roads S1, S2, which camera is shown schematically here and can capture the two vehicles 10, 20. The camera 50 is an infrastructure-side environmental sensor.

When the vehicles 10, 20 approach the intersection K, they are captured via the camera 50 and the vehicle-to-X communication. Data collected in this process are passed to the computing unit 30. The mechanisms mentioned are also used to capture the location, course and speed of the vehicles 10, 20 together with respective errors. The computing unit 30 is designed to create a respective prediction of trajectories and associated probabilities at several points in time as the vehicles 10, 20 approach the intersection K. In this case, the computing unit 30 calculates a plurality of trajectories for each vehicle starting from each point in time at which a corresponding measurement has taken place, wherein a certain probability is assigned to each trajectory. Based on these trajectories, collision probabilities at the intersection K are then calculated, i.e. it is calculated at which place and with what probability a collision can occur. This can be used to generate a heat map, i.e. an electronic map, which indicates a respective collision probability for certain points of the intersection K. The map can be normalized if required, or it can be created based only on specific data, for example based only on data recorded at specific times. Such maps can help planners to identify accident black spots and optimize them to increase traffic safety.

In general, it should be pointed out that vehicle-to-X communication is understood to mean in particular a direct communication between vehicles and/or between vehicles and infrastructure devices. By way of example, it may thus be vehicle-to-vehicle communication or vehicle-to-infrastructure communication. Where this application refers to a communication between vehicles, said communication can fundamentally take place as part of a vehicle-to-vehicle communication, for example, which is typically effected without switching by a mobile radio network or a similar external infrastructure and which must therefore be distinguished from other solutions based on a mobile radio network, for example. By way of example, a vehicle-to-X communication can be effected using the IEEE 802.11p or IEEE 1609.4 standard. Other examples of communication technologies include LTE-V2X, 5G-V2X, C-V2X, WLAN, WiMax, UWB or Bluetooth. A vehicle-to-X communication can also be referred to as C2X communication. The subareas can be referred to as C2C (car-to-car) or C2I (car-to-infrastructure). However, the embodiment explicitly does not exclude vehicle-to-X communication with switching via a mobile radio network, for example.

Mentioned steps of the method according to the application can be executed in the order indicated. However, they can also be executed in a different order, if technically feasible. In one of its embodiments, for example with a specific combination of steps, the method according to the application can be executed in such a way that no further steps are executed. However, in principle, further steps can also be executed, including steps that have not been mentioned.

It is pointed out that features may be described in combination in the claims and in the description, for example in order to facilitate understanding, even though these can also be used separately from one another. A person skilled in the art will recognize that such features, independently of one another, can also be combined with other features or combinations of features.

Dependency references in dependent claims may characterize preferred combinations of the respective features but do not exclude other combinations of features.

1. A method for creating a map with collision probabilities for an area, the method comprising:
detecting one or more vehicles driving in the area, and area;
determining movement data of the one or more vehicles;
predicting, for each vehicle among the one ore more vehicles, a trajectory based on the movement data of the vehicle;
calculating collision probabilities based on the trajectory; and
storing the collision probability in the map.

2. The method as claimed in claim 1,
wherein determining the movement data comprises repeatedly determining the movement data during a journey of the vehicle through the area, and
wherein the predicting comprises predicting the trajectory based on the journey.

3. The method as claimed in claim 2,
wherein determining the movement data are determined comprises determining the movement data at predetermined time intervals.

4. The method as claimed in claim 3, wherein the trajectory comprises a plurality of trajectories with respective associated probabilities.

5. The method as claimed in claim 4, wherein determining the movement data comprises determining the movement data by one or more road-side environmental sensors.

6. The method as claimed in claim 5, wherein determining the movement data comprises determining the movement data based on information received via radio from the one or more vehicles.

7. The method as claimed in claim 6, wherein the area comprises an intersection, a junction, a bend or a T-junction.

8. The method as claimed in claim 7, further comprising normalizing the collision probabilities are normalized to a reference value.

9. The method as claimed in claim 8, wherein the map comprises predefined subdivisions of the area.

10. The method as claimed in claim 9, wherein the predicting comprises predicting the trajectory based on prediction uncertainty and/or error limits of the movement data.

11. The method as claimed in claim 10, wherein the storing comprises storing the collision probability of a vehicle pairing including the vehicle.

12. The method as claimed in claim 11, wherein the storing comprises storing the collision probability from a predefined time window.

13. (canceled)

14. The method as claimed in any ene of the claim 12, further comprising determining one or more near-collision events based on the trajectory.

15. (canceled)
